(19) United States
(12) Patent Application Publication
(10) Pub. No.: US 2007/0101867 A1
(43) Pub. Date: May 10, 2007

(54) Air sterilization apparatus

(76) Inventors: Charles Eric Hunter, Jefferson, NC (US); Jocelyn L. Hunter, Jefferson, NC (US); Bernard L. Ballon JR., Raleigh, NC (US); John H. Hebrank, Durham, NC (US)

Correspondence Address: Vollrath & Associates;#531, 588 Sutter Street, San Francisco, CA, 94102, US

(21) Appl. No.: 11/317,045

(22) Filed: Dec. 23, 2005

Related U.S. Application Data
(63) Continuation-in-part of application No. 11/268,936, filed on Nov. 8, 2005.

(51) Int. Cl. B01D 46/00

(52) U.S. Cl. 96/224

(57) ABSTRACT

A portable sterilization apparatus that includes a face mask connected to a kill chamber having an ultraviolet source to destroy biological contaminants such as viruses, bacteria and fungi in air supplied to the mask, further includes a disposable particle filter in the kill chamber for filtering out particulates prior to irradiating the air with UV light, and in the case of a mercury vapor lamp UV source, a quartz sleeve surrounding the lamp. Valves are included in the face mask to limit carbon dioxide exhalation back into the kill chamber and to facilitate exhalation of air to the atmosphere.

### FIELD OF THE INVENTION

The invention relates to a method and apparatus for sterilizing air using ultraviolet (UV) radiation. In particular, it relates to an apparatus for killing harmful organisms such as viruses, bacteria and fungi, also referred to as organic material and biological contaminants. For purposes of this application the term “killing” also includes any DNA destruction.

### BACKGROUND OF THE INVENTION

Considerable work has been done in sterilizing water using mercury vapor lamps.

The use of vacuum UV sources to kill biological contaminants in air has also been considered. For instance, Brais, U.S. Pat. No. 5,833,740 discloses a chemical air purification and biological purification using UV sources, and making use of a turbulence generator mounted within the housing. Air purification by means of UV is also discussed in Kaura, U.S. Pat. No. 6,623,544B1. In this patent the air is treated with mechanical filters, ionization of energetic ions, and UV light radiation. Showdeen, et al., U.S. Pat. No. 5,446,289 also discusses the sterilization of articles by means of UV lamps mounted in a chamber.

However, the prior art making use of UV sources does not ensure that biological contaminants receive an adequate amount of radiation to render them harmless. Nor does it address power source limitations in portable devices, or consider the possible harmful byproducts of UV radiation, such as ozone and carbon monoxide.

Also there is no art that teaches actively destroying biological contaminants in a face mask assembly using ultraviolet radiation. When it comes to the field of face masks, masks with various types of filters are commonly known. Wadsworth, et al., U.S. patent application publication 2005/0079379 A1, for instance, describes an improvement on such a face mask using a two-layer or multi-ply barrier fabric having at least one barrier fabric layer which is impermeable to liquids but allows moisture vapor to pass through the micropores and in which the layers may contain an antimicrobial agent. Kirollos, et al., U.S. patent application publication 2004/0223876, in turn, describes exposure protection equipment such as a respiratory protection device, which includes a detector for indicating the presence of a target substance.

While Wen, U.S. patent application publication 2003/0111075 A1 describes a gas mask that kills bacteria, it does so using chemical agents. Wen makes use of a filtration apparatus containing an active stage and a passive stage, the active stage containing at least one chemical agent to kill ambient bacteria and viruses.

### SUMMARY OF THE INVENTION

According to the invention there is provided a portable air sterilization apparatus comprising a face mask, a kill chamber for destroying biological contaminants, wherein the chamber has an air inlet with a disposable particle filter, and an air outlet, and includes at least one ultraviolet (UV) light source, and a power source. For purposes of this application, the term face mask includes masks covering all or only portion of the face. Preferably the face mask and chamber are separably connected to one another. The face mask and kill chamber may be connected by a flexible delivery tube that is releasably connected to the face mask, and may include a quick release connector for releasing the tube from the face mask. The chamber may comprise an aluminum pipe in which the inner surface may be polished and may also be exposed to a chemical vapor deposition process to increase its UV reflectivity.

The UV light source may include at least one mercury vapor lamp or a plurality of UV emitting LEDs mounted in the chamber and generating at a wavelength of 240-280 nm, preferably at a wavelength of 260-265 nm. The apparatus typically includes a controller or processor, e.g. a microcontroller. In order to control the UV power at least some of the LEDs may be switched on and off according to a desired duty cycle or the power of at least some of the LEDs may be controlled in the range between on and off or a combination of such actions may be taken to control UV output power.

The inlet to the kill chamber may be defined by an end cap, and may further include a disposable filter assembly.

The power source may be connected to the kill chamber by means of flexible electrical connectors. The power source may comprise at least one rechargeable battery and may in addition or instead include a manually operated generator.

The kill chamber and power source may be carried in a hip pouch, or secured to the user's chest, or slung like a purse over the user's shoulder, or carried like a backpack on the user's back.

Typically the face mask is connected to the kill chamber by means of a delivery tube. The face mask typically includes a first portion covering the mouth and nose of the user, and may include a second portion covering the user's eyes. If the second portion does not form a unitary structure with the first portion, it may be provided with a separate air flow pipe from the kill chamber.

The face mask or the delivery tube preferably include a valve biased to a closed position and operable to open under air flow created by a user's inhalation or by an air flow pump generating sufficient pressure to open the valve. The face mask typically also includes an outlet valve that is biased to a closed position and operable to open under air flow created by a user's exhalation or by a user's exhalation in conjunction with a positive pressure created in the mask.

The portable air sterilization apparatus may include at least one air flow pump mounted in or on the kill chamber, which may be connected to the mask or the delivery tube and may be a low pressure pump for enhancing air flow to the user to ease breathing or may be a higher pressure pump for providing a positive pressure in the mask.

In the case where the UV light source comprises at least one mercury vapor lamp, the lamp is preferably protected by a quartz sleeve. One or both of the lamp and quartz sleeve may be made of 219 or 230 type, i.e., they may include titanium, thus blocking the 185 nm line, which creates ozone. The kill chamber may also include a shut-off valve for shutting off air flow to the face mask in the event that the UV lamp breaks, e.g. if a UV sensor detects a lack of UV radiation.

The portable air sterilization apparatus may include at least one of a UV radiation sensor for sensing the UV radiation, an air flow rate sensor, an ozone sensor, a carbon monoxide sensor, a visible light sensor, and an accelerometer. The controller preferably receives signals from the sensors and generates an alarm signal in response to a predefined sensor condition, which may be one or both of a visual and an audible alarm.

### BRIEF DESCRIPTION OF THE DRAWINGS

FIG. 1 shows a simplified representation of one embodiment of a portable sterilization apparatus of the invention;

FIG. 2 shows another embodiment of part of a sterilization apparatus of the invention;

FIG. 3 shows yet another embodiment of part of a sterilization apparatus of the invention;

FIG. 4 shows yet another embodiment of part of a sterilization apparatus of the invention;

FIG. 5 shows a user wearing yet another embodiment of a portable sterilization apparatus of the invention;

FIG. 6 shows a longitudinal section through part of another embodiment of a sterilization apparatus of the invention;

FIG. 7 is a top view of the embodiment of FIG. 6;

FIG. 8 shows a cross section through the apparatus of FIG. 6 along the line A-A;

FIG. 9 shows a side view of the apparatus of FIG. 6 connected to a mask shown in three dimensions;

FIG. 10 is a three dimensional view of another embodiment of a mask assembly of the invention;

FIG. 11 is a three dimensional view of another embodiment of a mask assembly of the invention;

FIG. 12 shows a block diagram of one embodiment of the electronic circuitry of the invention;

FIG. 13 is a three dimensional view of another embodiment of a kill chamber of the invention;

FIG. 14 is section through part of the embodiment of FIG. 13;

FIG. 15 is a section through another part of the embodiment of FIG. 13;

FIG. 16 shows one embodiment of a kill chamber and power supply in duplicate, housed in a fanny pack, and

FIG. 17 shows another embodiment of a kill chamber and power supply housed in a fanny pack.

### DETAILED DESCRIPTION OF THE INVENTION

One embodiment of a portable air sterilization apparatus of the invention is shown in figure one, which shows a face mask 100 connected to a kill chamber 110 by means of a flexible delivery tube 120. The face mask 100 includes a one-way intake valve 122 and a one-way exhaust valve 124. The face mask 100 fits over a person's nose and mouth with the exhaust valve 124 sending the exhaled air into the atmosphere. The intake valve 122 allows the person to inhale sterilized air. The one-way valves 122, 124 ensure that the person breathes sterilized air while eliminating the used air to the atmosphere. The valves 122, 124 may be simple flapper valves, over center flapper valves, or electrically actuated valves. In one embodiment, the valve open area was chosen correspond approximately to the cross-section of a human trachea (about 3-5 cm²). The delivery tube 120 which is preferably made of a flexible material is chosen to have a similar cross-section (3-5 cm²). In a preferred embodiment, the mask 100, valves 122, 124, and delivery tube 120 are designed to be removable from the kill chamber or sterilizer chamber 110 to facilitate washing, and are preferably made of a dishwasher safe material. In one embodiment, the apparatus may include eye protection such as glasses or goggles, or a flip-down transparent visor as indicated by reference numeral 130. The visor 130 of this embodiment includes a heads-up display and a receiver 190 for receiving external feed for displaying information on the display 130. The receiver 190 may be a wireless receiver e.g. a WiFi receiver for receiving wireless internet feed. In the embodiment shown, an air pump 170 is included in the chamber 110 to provide a positive pressure within the mask 100 thereby ensuring that the surrounding air is not inadvertently drawn into the mask 100 along its sides where it abuts the user's face. The pump 170 also serves to ease the inhaling process by providing an air flow toward the mask 100. One such pump is a diaphragm pump, e.g. 7010/−2.2N DC 12V and 24V produced by Rietschle Thomas of Sheboygan, Wis. Instead of pushing air directly to the mask, the pump, in another embodiment my supply a supply tank which then feeds the face mask via an appropriate regulator at the mask or tank.

In this embodiment, the sterilizer or kill chamber 110 has an internal volume corresponding approximately to one human breath of an adult under moderate exertion. (The typical breath of a resting adult is about 0.5 liter.) However, as is discussed in greater detail below, flow rate through the chamber is monitored to ensure that larger breaths and rapid breathing may be taken into consideration. In the present embodiment the kill chamber 110 is tubular in shape with a diameter of approximately three inches (3″) and six to eight inches (6-8″) in length. A UV light source 140 is mounted in the chamber 110. In one embodiment the UV light source is a mercury vapor lamp mounted by means of brackets (not shown) to extend substantially along the center of the chamber. In the embodiments using a mercury vapor lamp as the UV light source, the lamp is protected in a quartz sleeve to reduce the likelihood of breakage. Also, a sensor 172 is included to monitor the output of the mercury vapor lamp and close a valve 174 to the mask 100 if the lamp stops radiating. This will ensure that no noxious gases from the lamp, nor untreated air is passed into the user's lungs. Preferably multiple UV sensors are includes since they tend to degrade over time. Therefore multiple sensors to monitor the amount of UV radiation are beneficial in ensuring that the UV source produces sufficient UV. The sensor 172 can be a photodetector made from AlGaN, SiC, AlN, GaN, InGaN, AlInGaN, GaAs, Si, or AlN:SiC alloys. Preferably the photodetectors are filtered to cut out wavelengths that are not cut out by the earth's ozone layer (currently 280 nm and above), either by means of an on-chip deposited filter, e.g. doped SiO₂, or by means of a separate filter such as those sold by the company Schott in Mainz, Germany. The filtering ensures avoiding incorrect readings caused by extraneous UV interference. Preferably additional photodetectors clipped at 400 nm are included that measure light above 400 nm (visible light) to ensure that there is no light leakage into the chamber. This ensures that there are no gaps in the chamber that would allow UV light to escape.

It will be appreciated that the dimensions of the chamber 110 may vary depending on the nature, size, and configuration of the UV light source. The inner surface of the chamber 110 is coated with a UV reflective coating, such as aluminum so that radiation from the UV light source 140 will pass through the air in the chamber multiple times. Such reflective coatings have been found to produce 95% reflectivity of UV radiation. It will be appreciated that the UV source 140 may instead comprise an array of LEDs generating UV light. A wavelength of two hundred sixty to two hundred sixty-five nanometers (260-265 nm) has been found to be effective in killing or rendering harmless biological contaminants such as viruses, bacteria, and fungi.

The UV light source in this embodiment is powered by means of a power source which, in this embodiment, comprises a battery pack 142. The power source 142 may include a DC to AC converter to facilitate the provision of 120 volts AC or more for powering a mercury vapor lamp from a battery such as a 10 volt DC battery. It will be appreciated that the power supply will include appropriate ballasting circuitry. In the case of LEDs being used as the UV source, the power source will provide the appropriate LED current by means of an appropriate DC voltage converter or through the use of optimized circuitry for LEDs as produced by MAXIM. The battery pack constituting the power supply 142 in this embodiment is packaged integrally with the chamber and includes a charger for the battery pack. However, it will be appreciated that the battery pack could also be separately housed and carried, for example, on a user's belt. It will be appreciated that not only the kill chamber with its sensors and battery pack could be carried separately, but any other elements that are not required to be on the mask 100 could also be carried separate from the mask, e.g., in a backpack, shoulder bag, etc. Thus, for example any cell phone, AM/FM radio, walkie-talkie, or visor information receiver or could be housed carried in a backpack with the kill chamber 110.

The present invention seeks to conserve power while ensuring effective destruction of harmful organic material. In order to conserve power, rate of airflow through the chamber 110 is monitored by means of a flow meter 144, which may be a mechanical flapper, pressure sensor across a venturi, an anemometer, or a mass flow meter. The mass flow meter produced by MKS Instruments essentially comprises a wire loop that is heated by passing current through it and for which changes in current flow are monitored in order to maintain a substantially constant temperature wire loop. Thus, faster airflow, which will cause greater cooling will require greater current to maintain the temperature of the loop, thereby providing a simple way of measuring air flow rate. It will be appreciated that ambient temperature changes will affect the reading of the mass flow meter. The present embodiment therefore makes use of a second mass flow meter 145 that is exposed to the same ambient temperature but placed in a housing to avoid exposure to air flow, thereby acting as a control device. The differences in reading between the two flow meters will therefore represent a flow rate change. A controller in the form of a microprocessor 146 is connected to the sensor or flow meter 144 to monitor air turnover in the chamber 110 and adjust the UV dosage. The amount of UV radiation to which the air in the chamber 110 is exposed is adjusted by adjusting the radiation source. In one embodiment, a bank or matrix of UV LEDs was switched on and off according to a duty cycle as defined by the microprocessor 146. In addition, in another embodiment, the microprocessor 146 controlled the intensity of some or all of the LEDs in a bank or array of LEDs. In yet another embodiment, the microprocessor 146 selected the number of LEDs that needed to be switch on in order to account for changes in flow rate. It will be appreciated that a combination of two or more such power changes to the LEDs can be implemented.

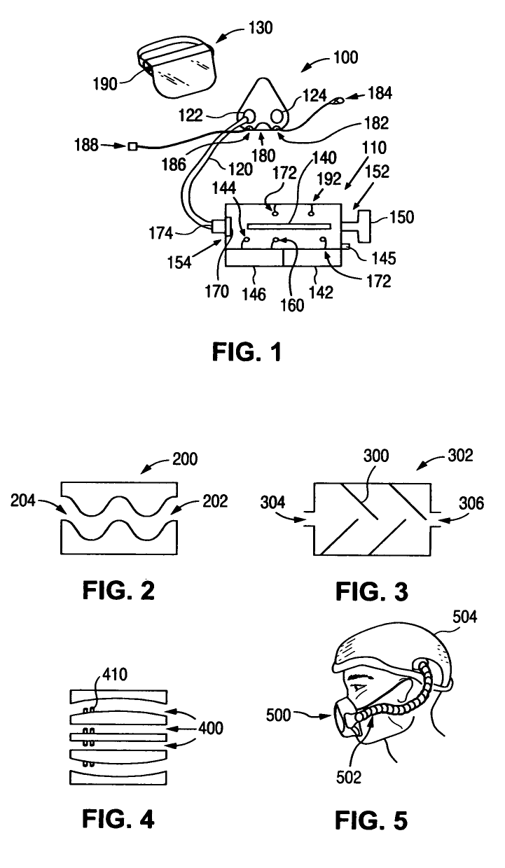

FIG. 1 also shows a filter 150 provided at the air intake 152 to the chamber 110. This filter 150 reduces microbes, dust, or mold entering the chamber 110, thereby reducing contaminants from settling on the chamber's reflective inner surface and compromising its reflective qualities.

Since UV light can increase the production of ozone (O₃) and carbon monoxide (CO), the present invention seeks to both monitor and limit the levels of ozone and carbon monoxide. Ozone production can be limited by optically filtering out one hundred eighty-five nanometer (185 nm) UV. Philips, for example, produces a mercury vapor lamp that provides such filtering by providing a titanium-doped glass (type 219 or 230) The carbon monoxide level can be reduced by providing a titanium dioxide layer for chemically reacting with carbon monoxide to produce carbon dioxide (CO₂). In order to avoid the carbon monoxide catalyst material from interfering with the reflective coating material in the chamber 110 the carbon monoxide catalyst is preferably provided in a separate section such as the delivery tube 120 or a portion of the chamber 110 near the outlet 154.

Yet another portion of the chamber 110 may be coated with a catalyst layer such as titanium dioxide (TiO₂) which promotes the breakdown of carbon compounds in the presence of UV light, thereby enhancing the kill effectiveness of the apparatus.

The present invention further includes sensors 160, 162 for monitoring ozone levels and carbon monoxide levels, respectively, in the chamber 110. The signals from the sensors 160, 162 may be sent to a visual display. Preferably, an auditory alarm is included for notifying the user if carbon monoxide or ozone levels exceed a predefined level. In one embodiment, a battery-charge monitor was also included to monitor the amount of battery charge left in the battery pack of power supply 142 and to notify the user both visually and by means of an audible alarm if power levels drop below a predefined minimum charge. As discussed above, this embodiment also includes a UV radiation sensor 172 to detect UV generation failure. The sensor 172 and possibly additional UV sensors also serve to monitor UV radiation and allow adjustment to meet an adequate dose without generating excessive undesirable byproducts. Since the effectiveness of the radiation source is effected by humidity conditions, the present embodiment includes a humidity sensor 192 connected to the controller 146 for controlling the amount of UV radiation pursuant to humidity changes.

As shown in FIG. 1, the mask 130 also includes a microphone 180 to facilitate communication. In order to allow the user to readily use a cellular phone, a cell phone speaker 182 is included in the mask 130 and is either connected to or connectable to a cell phone speaker/ear piece 184. In this embodiment, the mask 100 also includes a walkie-talkie microphone 186 connected to a walkie-talkie speaker 188 to facilitate communication with other workers. The kill chamber 110 also includes an AM/FM radio to allow the user to listen to public announcements and entertainment channels.

Another embodiment of the invention is shown in FIG. 2 in which the chamber 200, instead of having a linear passageway has a wavy passageway to promote turbulent airflow between the inlet 202 and the outlet 204. This ensures that air exposure to the surfaces of the chamber are increased, thereby increasing the effectiveness of the carbon monoxide catalyst. It will be appreciated that the wavy chamber configuration is particularly important in the section of the chamber that is provided with the carbon monoxide catalyst and may, in fact, be limited to this section only.

FIG. 3 shows yet another embodiment of the invention in which baffles 300 are provided in the kill chamber 302 thereby again providing turbulent airflow between the inlet 304 and the outlet 306.

Yet another embodiment is shown in FIG. 4. Here the chamber is divided into narrow passageways 400, each with ultraviolet LEDs 410, thereby ensuring more uniform exposure of the air in the chamber to ultraviolet radiation.

An alternative configuration for the mask and kill chamber is shown in FIG. 5, in which the mask 500 is connected by a flexible delivery tube 502 to a helmet-mounted kill chamber mounted on or integrally formed. In this embodiment, the kill chamber is integrally formed into a helmet 504. It will be appreciated that in another embodiment the chamber could merely be attached to an outer surface of a helmet such as a bicycle helmet.

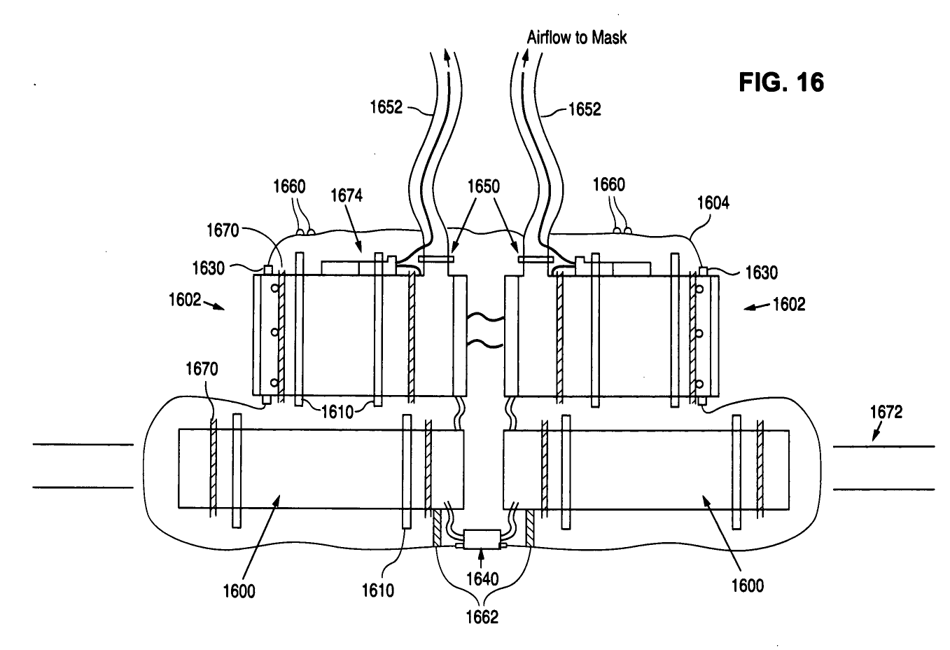

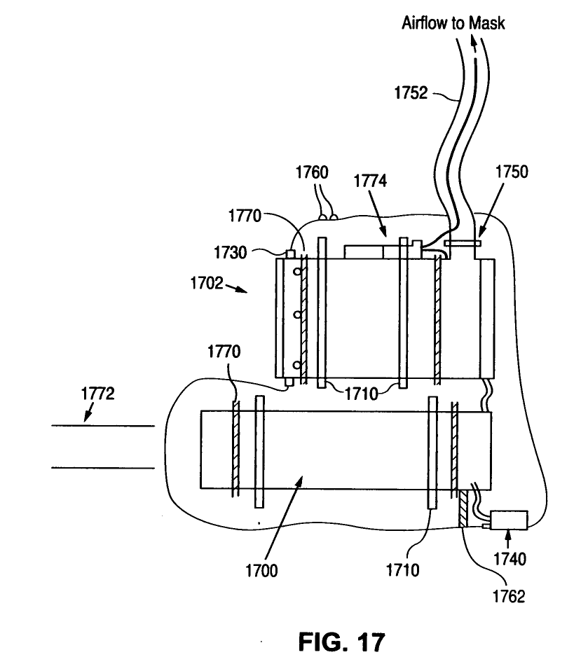

It will be appreciated that the battery pack, instead of being packaged into the helmet 504, may be attached to the user's belt, or to the user's chest, or slung like a purse over the user's shoulder, or carried like a backpack on the user's back, or carried on the user's hips in a hip pouch (fanny pack) arrangement as discussed further below with respect to FIG. 16-17.

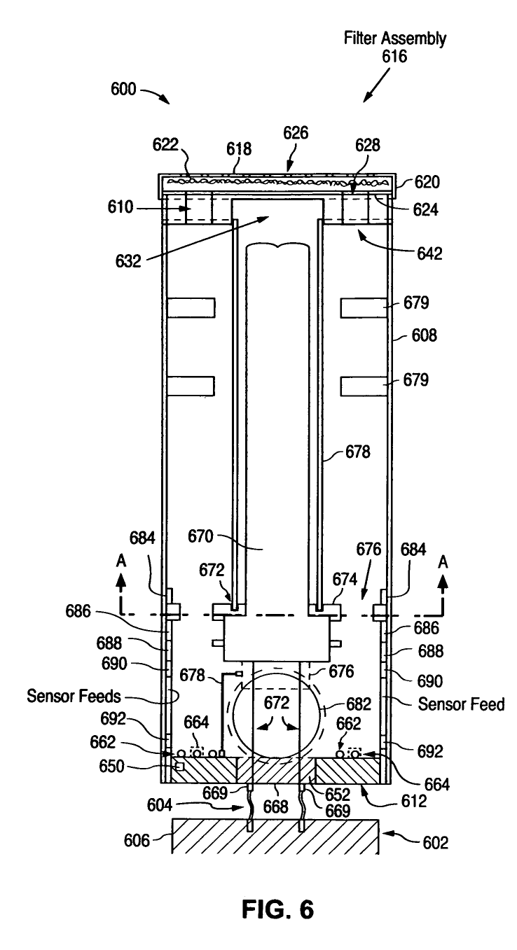

Part of yet another embodiment of the invention is shown in FIG. 6, which includes a UV housing or kill chamber 600 connected to a power supply 602 by means of flexible electrical connectors 604. In this embodiment the power supply 602 comprises several batteries (not shown) housed in a housing 606. Eight Lithium Ion batteries from Sanyo, producing 14.4 V and 64 W Hrs, and weighing 400 grams were used in this embodiment. In another embodiment twelve Nickel Metal Hydride (NiMH) batteries such as the HR-4/3 FAU 4500 were used in this embodiment. These produced 4500 mA hours each for a total of 54 W hours. Thus for approximately a 5 W lamp, a 1 Watt air flow pump and some 0.2 W for supporting electronics, the power supply of this embodiment would provide about 8 hours of operation before requiring that the batteries be recharged. These batteries have an 18 mm diameter and are about 67.5 mm long, thus allowing them, in one embodiment, to be packaged into a housing 606 that is about 135 mm×36 mm×54 mm by placing three rows of two batteries on top of a second set of three rows of two batteries. It will be appreciated that other configurations and other types of batteries e.g., NiCd kRF 7000F batteries from Sanyo, or HR-4/3FAU4500 batteries could be used as the power supply 602.

In this embodiment the housing of the kill chamber 600 is made of a 4.125 inch long, 2.5 inch inside diameter aluminum pipe 608 with a wall thickness of 3 mm and, which is preferably polished on its inner surface to provide a highly UV reflective inner surface. The pipe 608 can even be exposed to a chemical vapor deposition (CVD) process to increase the reflectivity to about 95 percent for UV. Apart from its structural integrity, the aluminum also provides a good thermal conductor for heat generated by the UV lamp 670 and the electronics, which are discussed further below. The pipe 608 defines a housing by being provided with end plugs 610, 612. The end plug 610 is fitted into the upper end of the pipe 608. The pipe also receives a removable filter assembly 616, which together with the end plug 610 will also be referred to as the end cap. The pipe 608 is provided with an outer thread on its upper, outer surface for complementarily engaging the filter assembly 616. The filter assembly comprises a filter housing defined by a filter cap 618 having side walls 620 with an inner thread that engages the outer thread on the pipe 608. The filter cap 618 houses a filter 622 and is closed off by a base plate 624. The filter cap 618 has numerous small holes or air flow passages 626, while the base plate 624 is provided with six 0.65 inch diameter holes 628. In this embodiment the filter 622 is a 0.3 micron particle filter that is equivalent to the N95 3M NIOSH standard.

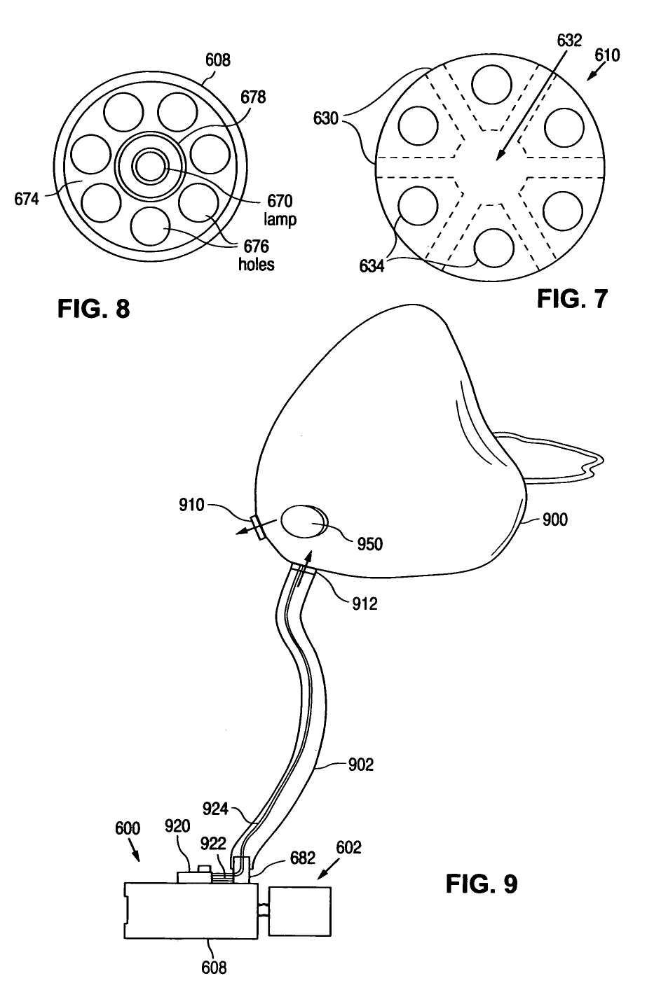

The upper end plug 610 is best understood with respect to the top view of the kill chamber shown in FIG. 7. The plug 610 is made of UV resistant material (e.g., Xylex materials X8210 or X7110 made by General Electric). It defines radial flow passages 630 joining at a central hole 632. The hole 632 and passages 630 allow mercury vapor from the mercury vapor lamp 670 to be vented out of the kill chamber in case the lamp 670 breaks. As discussed further below and as shown in FIG. 6, the kill chamber includes a UV light source in the form of a mercury vapor lamp 670 and a fused quartz sleeve 678 that protects the lamp 670. The sleeve 678 is held in position by the upper plug 610 by fitting into the central hole 632, which, as shown in FIG. 6 extends only partially through the plug 610. The plug 610 is, however, provided with six 0.65 inch diameter holes 642, which pass all the way through the plug and align with holes 628 in the base plate 624 for air flow into the kill chamber surrounding the sleeve 678.

The bottom end plug 612 supports the electronics of the air sterilization apparatus, which include a controller or processor, a voltage regulator, and sensor electronics, collectively indicated by reference numeral 650. In this embodiment the plug 612 includes a printed circuit board (PCB) on which the electronics are mounted. The PCB also supports photodetectors 662 for detecting the presence of light with a wavelength greater than 400 nm (visible light), thereby indicating that outside light is penetrating the kill chamber and that the chamber is open to UV radiation leakage. Audible alarms 664 are also provided to produce auditory feedback on various sensor conditions, as is discussed in greater detail below. An electrical connector plug 668 with pins 669 is mounted into the end plug 612 for connecting the flexible electrical connectors 604. As shown in FIG. 6, a UV lamp 670 mounted substantially along the longitudinal axis of the pipe 608 is electrically connected to the pins 669 of the connector plug 668 by means of electrical leads 672.

The lamp 670 should provide about 0.8 W output and a 253.7 nm wavelength. In this case a G23-2 Pin lamp (PL-S5W/TUV) from Philips, which is a SW lamp with a 1 W output, is mounted on a UV resistant plastic plate 674. The lamp 670 is provided with a ballast 676. Wires 678 extend from a power controller to the ballast 676. The plate 674, which is cemented into the pipe 608 includes a plurality of holes 676 to provide air flow passages as shown more clearly in the sectional view FIG. 8 through the apparatus along line A-A of FIG. 6. The lamp 670 is protected by a UV transparent tube, which in this case is a fused quartz sleeve 678, which surrounds the lamp 670 and is secured between between the plug 610 and an annular groove 672 in the plastic plate 674 to define a lamp housing separate from the air flow region surrounding the sleeve 678. The sleeve 678 of this embodiment has a 3 mm wall thickness, and in this embodiment both the lamp 670 and the sleeve 678 are made of 219 of 230 type, thus including titianium to eliminate the 185 nm line, which produces ozone. Other embodiments simply make use of the 219 or 230 type in either the mercury vapor lamp or the quartz sleeve.

As shown in FIG. 6, the kill chamber 600 also includes baffles 679 that are provided as annular plastic disks to promote turbulent air flowing for air flowing through the kill chamber. The annular plastic disks 679 are 0.7 inches thick and have a 1.75 inch diameter central hole.

In order to connect the kill chamber 600 with a face mask (discussed further with respect to FIG. 9) the aluminum tube 608 has a hole in its wall with an outwardly extending flange 682 acting as a hose connector for connecting the hose that leads to the face mask. During use, air is drawn into the housing or chamber 600 surrounding the quartz sleeve 678 through the openings or holes 626 in the filter cap 618, through the filter 622, through the channels 628 in the base plate 624, and through the holes 642 in the top plug 610. The air is then irradiated by UV light from the lamp 670, and passes out of the chamber through the hose connector 682 to the user's face mask.

As shown in FIG. 6, various sensors are mounted on the inner wall of the tube 608. These include UV sensors in the form of photo detectors 684 for sensing whether and how much UV is being put out by the lamp 670; thermistors 686 acting as hot wire air flow sensors; ozone sensors 688; CO sensors 690; accelerometers 692 for measuring any unwanted jarring or dropping of the apparatus which may have damaged the apparatus. The various sensors are electrically connected to the controller or processor 650 for monitoring the conditions and providing auditory feedback by means of the audible alarms 664 if predefined conditions are not met. For instance, a look-up table can pre-define suitable operating ranges and the controller or processor, which can be a microcontroller, can monitor the sensors and compare the sensor signals to the predefined values or ranges for signaling an alarm if the predefined values or ranges are not met. The audible alarms 664 can, for example, include an audible output generator such as a beeper or voice generator. In addition to the audible alarms, visual alarms, e.g., in the form of LEDs may be attached to an outer container or housing in which the kill chamber is carried.

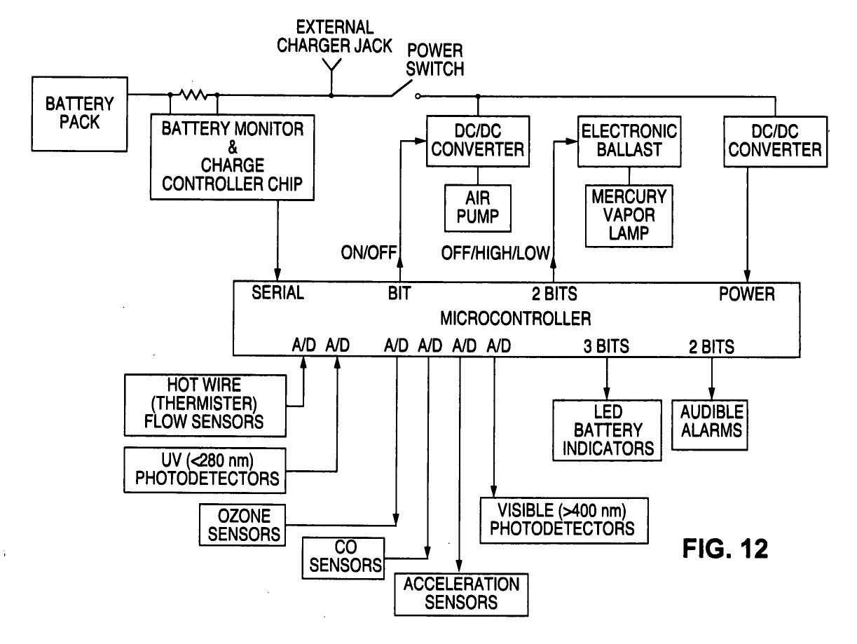

A block diagram of one embodiment of the electronics is shown in FIG. 12, including the microcontroller, the sensors and the power supply control circuitry for the microcontroller, an air pump (as is discussed in greater detail with respect to FIG. 8) and a mercury vapor lamp as used in the FIG. 6 embodiment. As shown in FIG. 12, this embodiment includes a battery monitor and charge controller chip to avoid overcharging of the batteries in the battery pack that serve as the power supply for the apparatus.

FIG. 9 shows the apparatus 600 with its power supply 602 connected to a mask 900 by means of a flexible pipe or tube 902, which in this embodiment is a ⅝ inch diameter plastic pipe. However, tube diameter and length are preferably adjusted to accommodate size differences and breath volume and breath frequency differences found in children, women and men. The mask 900 covers only the user's nose and mouth and includes a flapper valve 910 for allowing exhaled air to be vented to the atmosphere. The connector or flange on the mask 900 for connecting the hose 902 is a quick release valve requiring two tabs to be depressed on opposite side of the connector for releasing the hose 902. The connector also includes a flapper valve 912 that is spring loaded to bias the valve 912 to a closed position so that the valve 912 is closed when the user exhales to ensure that carbon dioxide rich air is vented to the atmosphere rather than back into the apparatus 600. As shown in FIG. 8, the apparatus 600 also includes an air pump 920, which in this case is a microdiaphragm air pump providing 4-6 standard liters per minute (SLM) at one atmosphere pressure (14.7 pounds per square inch). The pump 920 has an input tube 922 entering the hose connector or flange 682 of the aluminum tube 608 through a hole in the wall of the flange 682. The output from the pump 920 is connected by means of a pipe 924 to the mask 900 by passing through the wall of the flange or hose connector 682 and extending along the inner surface of the tube 902, through the valve 912, and into the face mask 900. In another embodiment, to avoid interfering with the valve 912, the hose 924 may pass out of the pipe 902 near the top of the tube 902 and into the mask In this embodiment the pump 920 is a low pressure pump (e.g. 1.46 pounds per square inch (psi)) serving merely to assist the user in breathing and being insufficient to open the valve 912 to the mask 900. In another embodiment the pump 920 is a higher flow pump (e.g., 33 psi) that not only assists in the breathing process but also forces the valve 914 open and creates a positive pressure in the mask 900 to provide an extra precaution against the ingress of untreated air into the mask 900 along the mask periphery. The higher flow pump also ensures consistent flow rate through the kill chamber. It will be appreciated that by appropriately choosing the tube 902 diameter and length the diaphragm pump 820 can optionally be eliminated altogether, thereby limiting cost and power consumption. It will also be appreciated that by connecting the pump as shown in FIG. 9, natural air flow is not restricted should the pump ever fail.

The invention also proposes including a port or connector to the kill chamber, mask or connecting hose or tube for introducing external substances, e.g. inhalants, nebulizers or atomized medicinal substances. One type of connector would be a pump canister receptor as is commonly known for pump action dispensers. A pump canister connector 950 is, for instance, shown in FIG. 9.

In order to provide an apparatus usable in rural areas or areas where power supplies or charging facilities are not readily available, one embodiment includes a manually operated power source e.g. a hand cranked generator that either charges a set of batteries or directly powers the UV source and other electronics. Such hand cranked generators are currently being used in devices such as portable radios and flashlights.

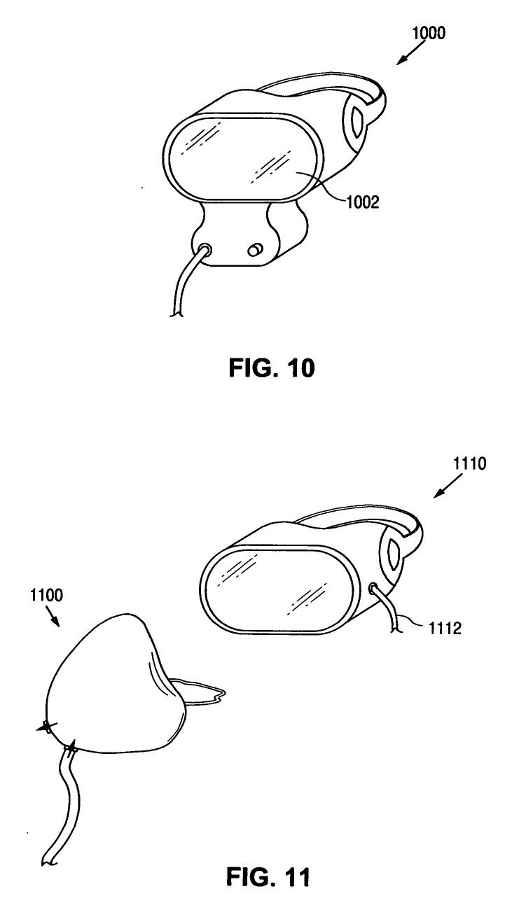

In the FIG. 9 embodiment, in which the mask 900 covers only the nose and mouth, the user will typically wear safety glasses or goggles to protect the eyes. In another embodiment, shown in FIG. 10, the mask assembly 1000 includes goggles 1002 having scratch resistant plastic lenses. In yet another embodiment, shown in FIG. 11 the mask 1100 again covers only the mouth and nose, but in this embodiment the system includes goggles 1110 that seal to the user's face and are provided with a separate air tube 1112 that is fed by an air pump such as the diaphragm pump 920 or by a separate air pump that pumps UV treated air.

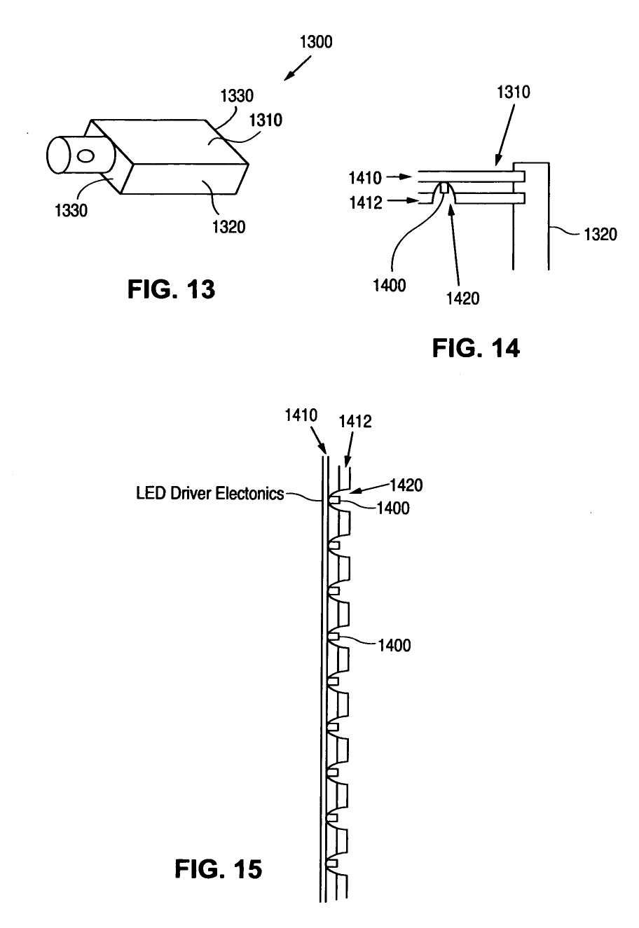

While the embodiment of FIG. 6 makes use of a mercury vapor lamp 670, the UV source could also be provided by LEDs as shown in FIGS. 13-15. For instance, InAlGaN LEDs with a dominant wavelength of 265 mn were used in one embodiment. In order to kill avian flu, for instance, 82.8 erg/mm² is required. Since there are 107 erg in a Joule of energy, a light source providing 0.8 W provides 8×10⁶ erg/s. Typically an adult at rest will take 10 breaths/minute, thus providing a 6 second chamber time for each breath (assuming flow is not controlled by an air flow pump). Thus each breath of air is irradiated by 8×10⁶×6 erg. In an 8 cm tube with a cross sectional area of about 5000 mm², this provides 9600 erg/mm². Thus a 0.8 W output source will provide a safety factor of about 9600/82.8=115.94. An LED will produce about 1 mW output. Thus the source would need about 800 LEDs to provide the 0.8 W output considered above. If a safety factor of approximately 10 were considered sufficient, 80 LEDs would suffice. At 40 mA per LED, the 80 LEDs would draw 3.2 A of current and at 6V would require approximately 19 W of power. It will, however, be appreciated that the need for an accelerometer is less critical when a mercury vapor lamp is not used. In this embodiment the bank of LEDs 1400 are mounted along one or more of the inner walls of a rectangular housing 1300 as shown in FIG. 13. The two main sides 1310 of the rectangular housing 1300 are made of double sheets of aluminum 1410 shown in FIGS. 14 and 15, which fit into slots in UV resistant plastic panels 1320 forming the narrow sides of the housing. The ends 1330 of the housing are also made of UV resistant plastic and also receive the aluminum plates 1410 in slots. As shown in FIGS. 14 and 15, the UV LEDs 1400 are mounted in cups 1420 between the outer aluminum plate 1410 and the inner aluminum plate 1412, which is polished, is provided with holes to expose the cups 1420.

As discussed above, the kill chamber and power supply can be carried in a fanny pack or hip pouch. Two embodiments of such a fanny pack arrangement is shown in FIG. 16-17. FIG. 16 shows dual battery packs 1600 constituting the power supply, and dual kill chambers 1602 housed in a fanny pack 1604. The dual nature of the kill chambers and battery packs provides for redundancy in case of failure of one or other of the components. In addition, both the battery packs 1600 and kill chambers 1602 are protected by annular foam disks 1610. The foam discs 1610 also serve to space the battery packs 1600 and kill chambers 1602 from the wall of the fanny pack for better air flow past the battery packs and kill chambers. The battery packs and kill chambers are secured relative to the fanny pack walls by means of elastic bands 1670 attached to the inner walls of the fanny pack. The kill chambers 1602 have their air inputs in flow communication with the outside by providing holes on opposite sides of the fanny pack 1604 and mounting the chambers 1602 by means of brackets 1630. In this embodiment, the battery packs 1600 are cooled by cooling exhaust feed lines from two micromotors with fans 1640, which are mounted between two plastic supports 1662 that are 2 inches in diameter. The embodiment of FIG. 16 also includes shut-off valves 1650 controlled by the controller of the kill chamber electronics. The valves 1650 close the tubes 1652 leading to the mask (not shown) in the event that a mercury vapor lamp breaks, i.e., if the UV detectors detect no UV radiation from a particular UV lamp. Also, if failure or inadequate UV radiation is detected, e.g., if the UV photodetectors detect no UV radiation within one or both of the kill chambers or the radiation level falls below a predefined level, alarms can be activated. As mentioned above, alarm conditions can be both visually and audibly identified. In this embodiment, LEDs 1660 are mounted on the fanny pack to provide the user with visual alarm information. Here several LEDs are provided, with different colors to provide different types of information. For instance, a green, amber and red LED can be provided for the kill chamber to indicate that the unit is good to use, or that the pump is down, or that no UV is being generated, respectively. Similarly, a green, amber and red LED can be provided for the battery pack to indicate, for example, that the battery pack is adequately charged (more than ½ hour left), or has less than ½ hour left, or has less than 5 minutes left, respectively. Regarding the shutoff valve, it will be appreciated that the shut-off valve 1650 is not necessary where the UV light source is provided by a bank of UV LEDs. Also, by providing the connection between the tube 1652 and the face mask as a separable connection and providing the connection with a quick release connector, e.g. oppositely positioned depressable tabs on the connector, the pipe can readily be removed in the event that the shut-off valve 1650 is closed. In one embodiment the fanny pack includes a pouch or Velcro patch for holding a snap-on particle filter that is attachable to the face mask using a similar quick-release connector, once the tube 1652 is removed.

In the FIG. 16 embodiment the fanny pack 1604 is made from waterproof material on its top and sides for helping to contain any mercury vapor in the event of a mercury vapor lamp breakage. The fanny pack 1604, however, is provided with a mesh bottom portion to help with air circulation and cooling of the battery packs 1600 and kill chambers 1602.

Another embodiment of the fanny pack arrangement is shown in FIG. 17. In this embodiment there is no redundancy shown, but the power supplies 1700 and kill chambers 1702 are again mounted in parallel. The battery pack 1700 and kill chamber 1702 are protected by annular foam disks 1710. The foam discs 1710 also serve to space the battery pack 1700 and kill chamber 1702 from the wall of the fanny pack for better air flow past the battery packs and kill chambers. The battery packs and kill chambers are secured relative to the fanny pack walls by means of elastic bands 1770 attached to the inner walls of the fanny pack. The kill chambers 1702 have their air inputs in flow communication with the outside by providing holes on opposite sides of the fanny pack and mounting the chambers 1702 by means of brackets 1730. In this embodiment, the battery pack 1700 is cooled by cooling exhaust feed lines from micromotor with fan 1740, which is mounted next to a plastic support 1762 that is 2 inches in diameter and acts as a spacer between the power supply and the fanny pack. The embodiment of FIG. 17 also includes shut-off valves 1750 controlled by the controller of the kill chamber electronics. The valves 1750 close the tubes 1752 leading to the mask (not shown) in the event that a mercury vapor lamp breaks, i.e., if the UV detectors detect no UV radiation from a particular UV lamp. Also, if failure or inadequate UV radiation is detected, e.g., if the UV photodetectors detect no UV radiation within one or both of the kill chambers or the radiation level falls below a predefined level, alarms can be activated. As mentioned above, alarm conditions can be both visually and audibly identified.

While the flexible connector hose 902 of FIG. 9 was a circular cross-section hose, other embodiments are also proposed by the present invention. For instance, a low profile rectangular, non-collapsible, yet flexible airline could be used instead. This could be worn beneath clothing and connect to the side of the mask to reduce snagging.

While various specific embodiments have been described above for the invention, it will be appreciated that the present invention is not limited to the embodiments discussed, but includes other embodiments as defined by the scope of the claims.

What is claimed is:

1. A portable air sterilization apparatus comprising
a face mask,
a kill chamber for destroying biological contaminants, wherein the chamber has an air inlet with a disposable particle filter, and an air outlet, and includes at least one ultraviolet (UV) light source, and
a power source.

2. A portable air sterilization apparatus of claim 1, wherein the face mask and chamber are separably connected to one another.

3. A portable air sterilization apparatus of claim 1, wherein the chamber comprises an aluminum pipe.

4. A portable air sterilization apparatus of claim 3, wherein the inner surface of the pipe is polished.

5. A portable air sterilization apparatus of claim 3, wherein the inner surface of the pipe is exposed to a chemical vapor deposition process to increase its UV reflectivity.

6. A portable air sterilization apparatus 1, wherein the UV light source includes at least one mercury vapor lamp or a plurality of UV emitting LEDs mounted in the chamber.

7. A portable air sterilization apparatus of claim 6, wherein the UV light source comprises multiple UV LEDs generating at a wavelength of 240-280 nm.

8. A portable air sterilization apparatus of claim 7, wherein the UV light source comprises multiple UV LEDs generating at a wavelength of 260-265 nm.

9. A portable air sterilization apparatus of claim 1, further comprising a controller or processor.

10. A portable air sterilization apparatus of claim 6, wherein at least some of the LEDs are switched on and off according to a desired duty cycle.

11. A portable air sterilization apparatus of claim 6, wherein the power of at least some of the LEDs is controlled in the range between on and off.

12. A portable air sterilization apparatus of claim 3, wherein the inlet is defined by an end cap.

13. A portable air sterilization apparatus of claim 12, wherein the end cap includes a disposable filter assembly, which includes the disposable filter.

14. A portable air sterilization apparatus of claim 2, wherein the face mask and kill chamber are connected by a flexible tube having a circular or low profile rectangular cross-section.

15. A portable air sterilization apparatus of claim 1, wherein the power source is connected to the kill chamber by means of flexible electrical connectors.

16. A portable air sterilization apparatus of claim 15, wherein the power source comprises at least one rechargeable battery.

17. A portable air sterilization apparatus of claim 15, wherein the power source includes a manually operated generator.

18. A portable air sterilization apparatus of claim 17, wherein the kill chamber and power source are carried in a hip pouch, or secured to the user's chest, or slung like a purse over the user's shoulder, or carried like a backpack on the user's back.

19. A portable air sterilization apparatus of claim 1, wherein the face mask is connected to the kill chamber by means of a delivery tube.

20. A portable air sterilization apparatus of claim 19, wherein the face mask includes a first portion covering the mouth and nose of the user.

21. A portable air sterilization apparatus of claim 20, wherein the face mask further includes a second portion covering the user's eyes.

22. A portable air sterilization apparatus of claim 21, wherein the second portion does not form a unitary structure with the first portion, and is provided with a separate air flow pipe from the kill chamber.

23. A portable air sterilization apparatus of claim 20, wherein the face mask or the delivery tube includes a valve biased to a closed position and operable to open under air flow created by a user's inhalation or by an air flow pump generating sufficient pressure to open the valve.

24. A portable air sterilization apparatus of claim 23, wherein the face mask includes an outlet valve that is biased to a closed position and operable to open under air flow created by a user's exhalation or by a user's exhalation in conjunction with a positive pressure created in the mask.

25. A portable air sterilization apparatus of claim 24, further comprising at least one air flow pump mounted in or on the kill chamber.

25. A portable air sterilization apparatus of claim 21, wherein one of the at least one air flow pump has an input connected to the kill chamber or the delivery tube near the kill chamber and an output connected to the mask or the delivery tube near the mask.

26. A portable air sterilization apparatus of claim 25, wherein the air flow pump is a low pressure pump for enhancing air flow to the user to ease breathing.

27. A portable air sterilization apparatus of claim 25, wherein the air flow pump is a higher pressure pump for providing a positive pressure in the mask.

28. A portable air sterilization apparatus of claim 5, wherein the UV light source comprises at least one mercury vapor lamp that is protected by a quartz sleeve.

29. A portable air sterilization apparatus of claim 1, further comprising at least one of a UV radiation sensor for sensing the UV radiation, an air flow rate sensor, an ozone sensor, a carbon monoxide sensor, a visible light sensor, a power source monitor and an accelerometer.

30. A portable air sterilization apparatus of claim 29, wherein the controller is a microcontroller operable to generate an alarm signal in response to a predefined sensor or monitor condition.

31. A portable air sterilization apparatus of claim 1, further comprising a valve in the kill chamber or deliver tube operable to close in response to a broken UV lamp being detected.

32. A portable air sterilization apparatus of claim 1, further comprising one or both of at least a second kill chamber and at least a second power source.

33. A portable air sterilization apparatus of claim 1, wherein the UV light source is a mercury vapor lamp protected by a UV transparent sleeve defiling a lamp housing.

34. A portable air sterilization apparatus of claim 33, wherein the kill chamber includes vent openings for venting mercury vapor from the lamp housing to outside the kill chamber.

35. A portable air sterilization apparatus of claim 1, further comprising a power source monitor and at least one of a visual and audible alarm operable to be activated in the event of a predefined power level being detected.

36. A portable air sterilization apparatus of claim 14, wherein the face mask or delivery tube includes a port for introducing external substances.

37. A portable air sterilization apparatus of claim 30, wherein the alarm signal activates at least one of a visual and audible alarm.

38. A portable air sterilization apparatus of claim 37, wherein the visual alarm includes a three different colored LEDs for defining kill chamber sensor conditions, and three different colored LEDs for defining power source conditions.

39. A portable air sterilization apparatus of claim 33 wherein at least one of the mercury vapor lamp and the UV transparent sleeve contain titanium.

40. A portable air sterilization apparatus of claim 39, wherein the UV transparent sleeve is a fused quartz sleeve.

41. A portable air sterilization apparatus comprising
a face mask,
a kill chamber for destroying biological contaminants, wherein the chamber includes an air inlet and houses at least one mercury vapor lamp protected by a UV transparent sleeve defining a lamp housing, and
a power source.

42. A portable air sterilization apparatus of claim 41, wherein the chamber comprises an aluminum pipe.

43. A portable air sterilization apparatus of claim 42, wherein the inner surface of the pipe is polished.

44. A portable air sterilization apparatus of claim 42, wherein the inner surface of the pipe is exposed to a chemical vapor deposition process to increase its UV reflectivity.

45. A portable air sterilization apparatus of claim 41, wherein tile inlet is defined by an end cap.

46. A portable air sterilization apparatus of claim 45, wherein the end cap includes a disposable filter assembly, which includes the disposable filter.

47. A portable air sterilization apparatus of claim 41, wherein the face mask and kill chamber are connected by a flexible tube having a circular or low profile rectangular cross-section.

48. A portable air sterilization apparatus of claim 41, wherein the power source is connected to the kill chamber by means of flexible electrical connectors.

49. A portable air sterilization apparatus of claim 48, wherein the power source comprises at least one rechargeable battery.

50. A portable air sterilization apparatus of claim 47, wherein the face mask or the delivery tube includes a valve biased to a closed position and operable to open under air flow created by a user's inhalation or by an air flow pump generating sufficient pressure to open the valve.

51. A portable air sterilization apparatus of claim 50, wherein the face mask includes an outlet valve that is biased to a closed position and operable to open under air flow created by a user's exhalation or by a user's exhalation in conjunction with a positive pressure created in the mask.

52. A portable air sterilization apparatus of claim 51, further comprising a low pressure air flow pump for enhancing air flow to the user to ease breathing.

53. A portable air sterilization apparatus of claim 51, further comprising a higher pressure air flow pump for providing a positive pressure in the mask.

54. A portable air sterilization apparatus of claim 41, further comprising at least one of a UV radiation sensor for sensing the UV radiation, an air flow rate sensor, an ozone sensor, a carbon monoxide sensor, a visible light sensor, a power source monitor and an accelerometer, and further comprising a controller or processor for generating an alarm signal in response to a predefined sensor or monitor condition

55. A portable air sterilization apparatus of claim 41, further comprising a valve in the kill chamber or deliver tube operable to close in response to a broken UV lamp being detected.
